(19) United States
(12) Patent Application Publication
(10) Pub. No.: US 2006/0108427 A1
(43) Pub. Date: May 25, 2006

(54) Portable equipment

(75) Inventors: Ryohhei Kawamuki, Nara (JP); Renzaburo Miki, Kyoto (JP); Toshiyuki Tanaka, Osaka (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/286,512

(22) Filed: Nov. 22, 2005

(30) Foreign Application Priority Data
Nov. 24, 2004 (JP) 2004-339299

(51) Int. Cl. G06K 7/10

(52) U.S. Cl. 235/472.01

(57) ABSTRACT

Portable equipment (14) includes a housing (13), a first cushioning (12) and a camera module (10). The camera module (10) includes an optical component mounting portion (10A) having an optical lens and a CCD photodetecting portion, a camera module housing portion (10C) (mass body) and a second cushioning (10B). The camera module housing portion (10C) is connected to the optical component mounting portion (10A) via the second cushioning (10B). In the camera module (10), the upper surface and the bottom surface of the camera module housing portion (10C) are held by the housing (13) via the first cushioning (12). When an impact is applied to the housing (3), acceleration generated in the optical component mounting portion (10A) is reduced by the vibration of the camera module housing portion (10C). With this arrangement, the damage of the CCD photodetecting portion and so on due to a drop impact or the like can be prevented with a simple construction, allowing the portable equipment (14) to be downsized.

### CROSS-REFERENCE TO RELATED APPLICATIONS

The present non-provisional application claims priority based on JP 2004-339299 applied for patent in Japan on Nov. 24, 2004 under U.S. Code, Volume 35, Chapter 119(a). The disclosure of the application is fully incorporated herein by reference.

### BACKGROUND OF THE INVENTION

The present invention relates to portable equipment having a camera module and relates, in particular, to portable equipment of a structure intended to improve its impact resistance capability.

In recent years, portable equipment having a camera module is widely popularized. However, when the user accidentally drops such portable equipment, a rapid acceleration is generated in the camera module by an impact caused by fall and collision, possibly damaging the camera module. As portable equipment that prevents the damage of the camera module at the time of fall and collision, the following portable telephone device is well known.

As conventional first portable equipment, there is a portable telephone device with an image taking function, which is disclosed in JP 2004-61530 A and shown in FIG. 9. FIG. 9 is a sectional view schematically showing a portable telephone device 110 with an image taking function, and the portable telephone device 110 has a camera module 300 for image taking.

As shown in FIG. 9, the camera module 300 has an electrostatic actuator 310 for driving a focus control lens or a zoom lens. The electrostatic actuator 310 is constructed of movable member (not shown) on which a lens is mounted and a stator (not shown) formed in a rectangular parallelepiped shape in which a movement space of the movable member is provided in a prescribed direction.

The portable equipment equipped with such a camera module has had the following problems. That is, it is possible that the camera module may be damaged by a contact between the stator and the movable member of the electrostatic actuator, which have a gap of only about several micrometers therebetween, when the portable equipment is dropped to the floor or the like. Moreover, it is possible that the camera module may be damaged by a contact between the stator and the movable member even when the portable equipment is subjected to an impact or vibration during transportation in a vehicle.

In order to solve the problems, the conventional first portable telephone device is constructed as follows. As shown in FIG. 9, there is provided a housing 120 and a mount board 140 being housed in the housing 120 and the camera module 300 and electronic devices 141 are mounted on the mount board 140. The housing 120 has a first housing 121 and a second housing 122, which face each other, and the camera module 300 is held by the first and second housings 121 and 122 via cushionings 131 and 132, respectively.

In the portable telephone device 110 constructed as above, the camera module 300 is supported by the housing 120 via the cushionings 131 and 132. Therefore, even when the device is dropped to the floor or the like or subjected to an impact or vibration during transportation in a vehicle, the impact or the like is transmitted in alleviated form to the electrostatic actuator. Therefore, the stator and the movable member can be prevented from coming in contact with each other. With this arrangement, the damage of the camera module 300 can be prevented.

As in the conventional first portable telephone device, the camera module is hardly damaged since the impact transmitted to the camera module is alleviated by the cushionings made of rubber or gel provided between the housing and the camera module in the portable equipment.

Moreover, as a conventional second portable equipment, there is an equipments disclosed in JP 2003-167181 A. In this equipment similar to the portable telephone device shown in FIG. 9, a camera main body is connected to the lens-barrel unit housed therein via a cushioning, thereby an external force is eliminated and applied to the lens-barrel unit.

However, when such portable equipment is downsized, mechanical components are to be mounted with a high density in the narrow housing. Therefore, when an impact due to fall and collision or the like is applied to the housing to deform the same, other mechanical components such as the housing may collide with the camera module, and the camera module (particularly a portion where an imaging device is mounted on a ceramic substrate) may be damaged.

Moreover, the further the downsizing is promoted, the more difficult to secure a space for providing a cushioning for absorbing the impact, meaning that the thickness of the cushioning cannot help being reduced in thickness. In such a case, it becomes difficult to reduce the impact applied to the camera module by means of a cushioning as in the portable telephone device of the conventional first portable equipment.

### SUMMARY OF THE INVENTION

An object of the present invention is to provide portable equipment capable of easily preventing the damage due to a drop impact or the like with a simple construction and coping with downsizing without increasing the cushioning thickness.

In order to achieve the above object, there is provided a Portable equipment comprising:

a first camera module portion including an imaging device;

a second camera module portion that constitutes a camera module in combination with the first camera module portion;

a housing that houses therein the first and second camera module portions;

a first cushioning that connects either one of the first camera module portion and the second camera module portion to the housing; and

a second cushioning that connects the first camera module portion to the second camera module portion.

According to the portable equipment of the construction, by connecting either one of the first camera module portion and the second camera module portion to the housing via the first cushioning and connecting the first camera module portion to the second camera module portion via the second cushioning, the second camera module portion serves as a weight body for impact absorption and responds to a drop impact faster than the first camera module portion, absorbing energy due to fall and collision. With this arrangement, even if an impact is applied to the housing, the second camera module portion vibrates to absorb the impact so that the acceleration applied to the first camera module portion including the imaging device susceptible to an impact is reduced. Therefore, it is possible to easily prevent the damage due to a drop impact or the like with a simple construction and cope with downsizing without increasing the cushioning thickness.

In one embodiment of the present invention, the first camera module portion has the imaging device and an optical component, and the second camera module portion has a mechanical portion that holds or displaces the optical component.

According to the portable equipment of the embodiment, by reducing the acceleration applied to the first camera module portion having the imaging device and the optical components susceptible to an impact by using the second camera module portion having the mechanical portion for holding or displacing the optical components as the weight body for impact absorption, the imaging device and the optical components can be prevented from being damaged by fall or the like. Moreover, since the second camera module portion having the mechanical portion is used as the weight body, downsizing can be achieved without separately providing a weight body.

In one embodiment of the present invention, the portable equipment further comprises a third cushioning that connects the other of the first camera module portion and the second camera module portion to the housing.

According to the portable equipment of the embodiment, by connecting the other of the first camera module portion and the second camera module portion to the housing via the third cushioning, the third cushioning can absorb the impact in cooperation with the first and second cushionings.

In one embodiment of the present invention, masses of the first and second camera module portions and spring constants of the first and second cushionings are set so that a natural frequency of the second camera module portion becomes higher than a natural frequency of the first camera module portion.

According to the portable equipment of the embodiment, when the second camera module portion is connected to the housing via the first cushioning, by setting the masses of the first and second camera module portions and the spring constants of the first and second cushionings so that the natural frequency of the second camera module portion is made higher than the natural frequency of the first camera module portion, the second camera module portion responds faster than the first camera module portion to the impact to effectively absorb energy due to collision, and the acceleration applied to the first camera module portion including the imaging device can be reduced.

In one embodiment of the present invention, when the second camera module portion is connected to the housing via the first cushioning, the spring constant of at least the first cushioning is set to a value that a maximum acceleration of the first camera module portion due to an impact applied to the housing is roughly minimized.

According to the portable equipment of the embodiment, when the second camera module portion is connected to the housing via the first cushioning, an optimum value of the spring constant of at least the first cushioning is estimated by simulation or the like so that the maximum acceleration of the first camera module portion is roughly minimized when an impact is applied to the housing. The thus-estimated optimum value is set as the spring constant of the first cushioning. With this arrangement, the effect of reducing the acceleration to the first camera module portion including the imaging device susceptible to an impact is increased.

In one embodiment of the present invention, when the first camera module portion is connected to the housing via the first cushioning, the spring constant of at least the second cushioning is set to a value that a maximum acceleration of the first camera module portion due to an impact applied to the housing is roughly minimized.

According to the portable equipment of the embodiment, when the first camera module portion is connected to the housing via the first cushioning, an optimum value of the spring constant of at least the second cushioning is estimated by simulation or the like so that the maximum acceleration of the first camera module portion is roughly minimized when an impact is applied to the housing. The thus-estimated optimum value is set as the spring constant of the second cushioning. With this arrangement, the effect of reducing the acceleration to the first camera module portion including the imaging device susceptible to an impact is increased.

In one embodiment of the present invention, when the first camera module portion is connected to the housing via the first cushioning, a mass of the first camera module portion is larger than a mass of the second camera module portion, and a spring constant of the first cushioning is greater than a spring constant of the second cushioning.

According to the portable equipment of the embodiment, when the first camera module portion is connected to the housing via the first cushioning, by making the mass of the first camera module portion larger than the mass of the second camera module portion, parameters (masses of the first and second camera module portions as well as the spring constants and the viscosity coefficients of the first and second cushionings) for reducing the acceleration applied to the first camera module portion including the imaging device and the optical components susceptible to an impact can easily be designed. Moreover, by making the spring constant of the first cushioning for connecting the first camera module portion to the housing smaller than the spring constant of the second cushioning, downsizing can easily be achieved by reducing the thickness of the first cushioning.

Also, when the second camera module portion is connected to the housing via the first cushioning and an impact is transmitted sequentially from the housing, the first cushioning, the second camera module portion, the second cushioning and the first camera module portion, by making the mass of the second camera module portion larger than the mass of the first camera module portion, the parameters (masses of the first and second camera module portions as well as the spring constants and the viscosity coefficients of the first and second cushionings) for reducing the acceleration applied to the first camera module portion including the imaging device and the optical components susceptible to an impact can easily be designed.

It is noted that the first camera module portion may include part of the mechanical portion without being limited to the imaging device and the optical components.

Moreover, the second camera module portion plays the role of the mass body for impact absorption and may include a mechanical portion and an optical component.

Further, the object can be achieved with any one of rubber, gel and resin as the cushioning.

As is apparent from the above, according to the portable equipment of the present invention, portable equipment having a compact camera module, which is able to reduce the acceleration applied to the camera module due to an impact and to prevent the damage due to a drop impact or the like with a simple construction, can be provided.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a sectional view schematically showing the portable equipment of a first embodiment of the present invention;

FIGS. 2A and 2B are views showing physical models of the conventional portable equipment and the portable equipment of the first embodiment, respectively;

FIG. 3 is a characteristic graph showing responses to a drop impact in the first embodiment;

FIG. 4 is a sectional view schematically showing the portable equipment of the second embodiment of the present invention;

FIG. 5 is a view showing a camera module of the portable equipment of the second embodiment;

FIG. 6A and FIG. 6B are views showing the physical models of the conventional portable equipment and the portable equipment of the second embodiment, respectively;

FIG. 7 is a characteristic graph showing responses to a drop impact in the portable equipment of the second embodiment;

FIG. 8 is a characteristic graph showing the influence of a spring constant k42 in the second embodiment; and

FIG. 9 is a view schematically showing conventional first portable equipment.

### DETAILED DESCRIPTION OF THE INVENTION

The portable equipment of the present invention will be described in detail below by the embodiments shown in the drawings.

### First Embodiment

FIG. 1 is a sectional view schematically showing the portable equipment according to the first embodiment of the present invention. As shown in FIG. 1, the portable equipment 14 of the first embodiment includes a camera module 10, a first cushioning 12 and a housing 13 that houses therein the camera module 10 and the first cushioning 2. The camera module 10 has its upper surface and bottom surface held by the housing 13 via the first cushioning 12. When an impact is applied from external to the housing 13, the impact is buffered by the first cushioning 12 and transmitted to the camera module 10.

Moreover, the camera module 10 includes an optical component mounting portion 10A as one example of the first camera module portion, a second cushioning 10B and a camera module housing portion 10C as one example of the second camera module portion that houses therein the optical component mounting portion 10A and the second cushioning 10B. The optical component mounting portion 10A includes an optical lens (optical component) and a CCD photodetecting portion (imaging device) intended for image taking and a mechanical portion that retains the optical component and the CCD photodetecting portion although it is shown not in detail but schematically in FIG. 1. In this case, the CCD photodetecting portion (imaging device) is provided on a ceramic substrate.

The optical component mounting portion 10A is susceptible to an impact since it has the precision components of the optical lens, the CCD photodetecting portion and so on. Further, in order to keep a high positioning accuracy, the components are bonded together with an adhesive of a high Young's modulus. Since the adhesive lacks flexibility and has a low impact resistance, it is possible that the bonded portions may be separated by impact acceleration.

For the above reasons, the optical component mounting portion 10A is most susceptible to an impact among the mechanical components of the camera module 10. Therefore, the camera module housing portion 10C is served as a mass body, and the optical component mounting portion 10A is connected to the inner bottom surface of the camera module housing portion 10C via the second cushioning 10B. With this arrangement, an impact is buffered by the second cushioning 10B and thereafter transmitted to the optical component mounting portion 10A. Since the impact acceleration transmitted to the optical component mounting portion 10A is reduced and forces exerted on the precision components and the adhesive become reduced, no destruction occurs.

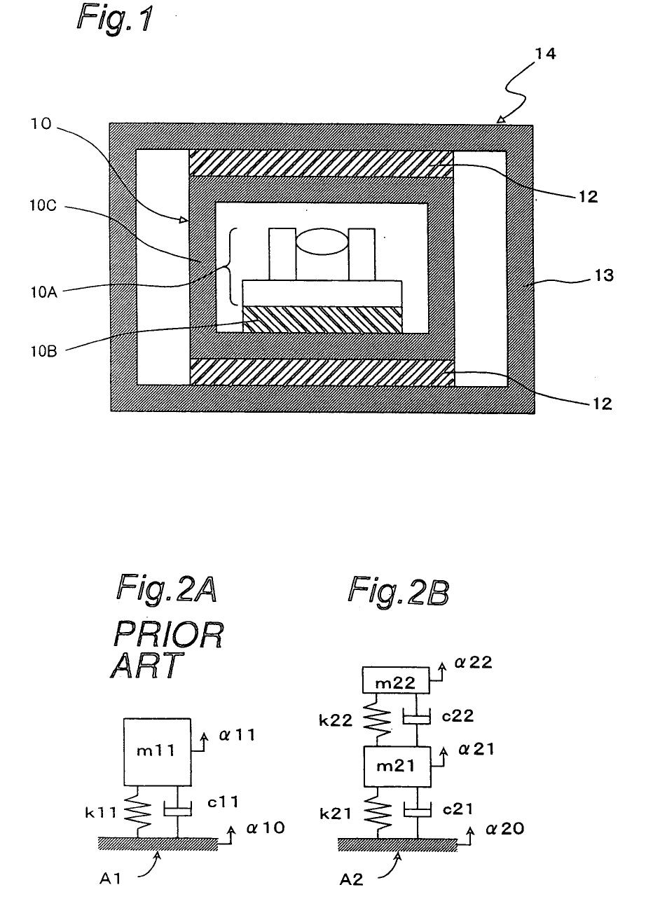

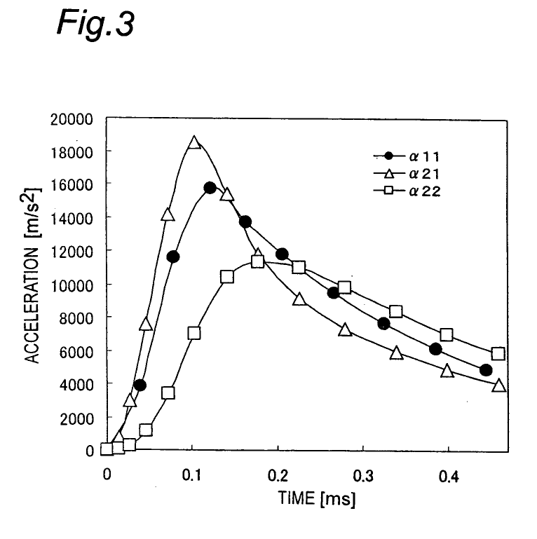

The reason why the impact resistance is improved in the portable equipment 14 that has the structure described above is described with reference to FIGS. 2A, 2B and FIG. 3.

The physical model A1 shown in FIG. 2A corresponds to the prior art portable equipment. In FIG. 2A, the physical model A1 has parameters set as follows.

Acceleration of housing: α10 [m/s²]

Spring constant of cushioning: k11=4.5×10⁴ [N/m]

Viscosity coefficient of cushioning: c11=100 [Ns/m]

Acceleration of camera module: α11 [m/s²]

Mass of camera module: m11=25×10⁻³ [kg]

Moreover, the physical model A2 shown in FIG. 2B corresponds to the portable equipment 14 of the first embodiment. In FIG. 2B, the physical model A2 has parameters set as follows.

Acceleration of housing 13: α20 [m/s²]

Spring constant of first cushioning 12: k21=4.5×10⁴ [N/m]

Viscosity coefficient of first cushioning 12: c21=100 [Ns/m]

Acceleration of camera module housing portion 10C: α21 [m/s²]

Mass of camera module housing portion 10C: m21=15×10⁻³ [kg]

Spring constant of second cushioning 10B: k22=1.0×10³ [N/m]

Viscosity coefficient of second cushioning 10B: c22=100 [Ns/m]

Acceleration of optical component mounting portion 10A: α22 [m/s²]

Mass of optical component mounting portion 10A: m22=10×10⁻³ [kg]

It is noted that the physical model A1 is a one-inertia system model that takes the acceleration α10 applied to the housing as an input and takes the acceleration α11 generated in the camera module as an output. On the other hand, the physical model A2 is a two-inertia system model that takes the acceleration α20 (=α10) applied to the housing 13 as an input and takes the acceleration α22 generated in the optical component mounting portion 10A as an output. The smaller the acceleration of the output, the smaller the force exerted on the camera module 10 and the optical component mounting portion 10A results with a reducing chance of damage.

When the physical model A2 is regarded as the first embodiment by comparison, the camera module is constructed of two constituent elements that have different natural frequencies. The natural frequency of the camera module housing portion 10C is expressed as:
ω21=\sqrt{k21/m21}≈1732 [rad/s]
and the natural frequency of the optical component mounting portion 10A is expressed as:
ω22=\sqrt{k22/m22}≈316 [rad/s]
That is, ω21>ω22. Therefore, the waveform of the acceleration α21 contains a greater amount of high-frequency components than the acceleration α22. Therefore, the camera module housing portion 10C responds to a drop impact faster than the optical component mounting portion 10A and absorbs energy due to fall and collision.

In the thus constructed portable equipment 14, the acceleration generated in the optical component mounting portion 10A can be reduced by the vibration of the camera module housing portion 10C even when an impact is applied to the housing 13.

FIG. 3 shows the responses of the physical models A1 and A2 to the fall and collision. In FIG. 3, the horizontal axis represents time, and the vertical axis represents acceleration. As to the physical model A1, the acceleration α11 generated in the camera module is plotted, while as to the physical model A2, the acceleration α21 generated in the camera module housing portion 10C and the acceleration α22 generated in the optical component mounting portion 10A are plotted.

It is noted that the response to the fall and collision expresses the calculated results of simulation of the accelerations α11, α21 and α22 generated by a drop impact.

Moreover, the drop impact was the acceleration generated in the housing by the fall and collision and herein expressed by a half-cycle sine wave pulse of a maximum acceleration of 60000 m/s² and an operating time of 0.13 ms corresponding to the acceleration generated in the housing when the portable telephone was dropped from a height of 1.7 m to concrete.

In FIG. 3, the maximum value of the acceleration all generated in the camera module is 16000 m/s² with regard to the prior art physical model A1. On the other hand, the maximum value of the acceleration α22 generated in the optical component mounting portion 10A is 11000 m/s², and this means that the acceleration can be reduced to 18.3% (≈11000× 100/60000) of the maximum acceleration of the drop impact with regard to the physical model A2. Since it is 26.7% (≈16000× 100/60000) in the portable equipment A1, the impact that is applied to the camera module is largely reduced by the present invention.

A member having elasticity and viscosity of, for example, a viscoelastic body made of rubber or gel, a spring or the like is used for the first cushioning 12 and the second cushioning 10B. The cushioning becomes hard and unable to sufficiently alleviate the impact when the elastic moduli of the first cushioning 12 and the second cushioning 10B are excessively large. Conversely, when the elastic moduli are excessively small, the cushioning is completely collapsed before sufficiently alleviating the impact and becomes unable to alleviate the impact. Moreover, when the viscosity coefficient is excessively large, the cushioning becomes hard and is also unable to sufficiently alleviate the impact. Conversely, when the viscosity coefficient is excessively small, the effect of attenuation cannot be obtained, and the impact cannot still be sufficiently alleviated. In the physical model A2 of the present first embodiment, the amount of contraction of the first cushioning is 0.96 mm, and the amount of contraction of the second cushioning is 0.5 mm. Assuming that the thickness of the first cushioning is 2.0 mm and the thickness of the second cushioning is 1.0 mm, then the distortion factor of the cushionings becomes 50% or less, and the impact can sufficiently be alleviated.

In the portable equipment 14 of the first embodiment described above, the first cushioning 12 and the second cushioning 10B have been formed so that the acceleration generated in the optical component mounting portion 10A at the time of the fall and collision have been able to be reduced by the camera module housing portion 10C connected to the optical component mounting portion 10A via the second cushioning 10B. That is, the parameters of the physical model have been set so that the natural frequency ω1 of the camera module housing portion 10C as the second camera module portion became higher than the natural frequency ω2 of the optical component mounting portion 10A as the first camera module portion. With this arrangement, the acceleration generated in the optical component mounting portion 10A at the time of the fall and collision is reduced in the portable equipment of the first embodiment.

Moreover, in order to protect the optical component mounting portion 10A that is particularly susceptible to an impact among the mechanical components of the camera module 10, the camera module housing portion 10C is served as a mass body for impact absorption in the first embodiment.

As described above, even when an impact is applied to the housing 13, the acceleration generated in the optical component mounting portion 10A that includes the imaging device susceptible to an impact is reduced by absorbing the impact by the vibration of the camera module housing portion 10C. Therefore, damage due to a drop impact or the like can easily be prevented with a simple construction without increasing the thickness of the cushioning. In addition, since the camera module housing portion 10C that is part of the camera module 10 concurrently serves as the mass body, compact portable equipment excellent in impact resistance can be provided.

Moreover, by reducing the acceleration generated in the optical component mounting portion 10A that has the imaging device and the optical components susceptible to an impact by using the camera module housing portion 10C as the weight body for impact absorption, the imaging device and the optical components can be prevented from being damaged by fall or the like. Moreover, by utilizing the camera module housing portion 10C as the weight body, downsizing can be achieved without separately providing a weight body.

Moreover, by making the natural frequency ω21 of the camera module housing portion 10C higher than the natural frequency ω22 of the optical component mounting portion 10A by setting the mass m21 of the camera module housing portion 10C and the mass m22 of the optical component mounting portion 10A and the spring constants k21 and k22 of the first and second first cushionings 12 and 10B, respectively, in the portable equipment in which the camera module housing portion 10C is connected to the housing 13 via the first cushioning 12, the camera module housing portion 10C effectively absorbs the energy of collision by responding to the impact faster than the optical component mounting portion 10A, thereby allowing the acceleration generated in the optical component mounting portion 10A that includes the imaging device to be reduced.

Furthermore, the optimum value of the spring constant k21 of the first cushioning 12 is obtained by simulation or the like so that the maximum acceleration of the optical component mounting portion 10A is roughly minimized. By setting the thus-obtained optimum value as the spring constant of the first cushioning 12, the effect of reducing the acceleration applied to the optical component mounting portion 10A that includes the imaging device susceptible to an impact is increased.

Moreover, by using a third cushioning for connecting the optical component mounting portion 10A to the housing 13 in the portable equipment of the first embodiment, the third cushioning can absorb impacts in cooperation with the first and second cushionings.

### Second Embodiment

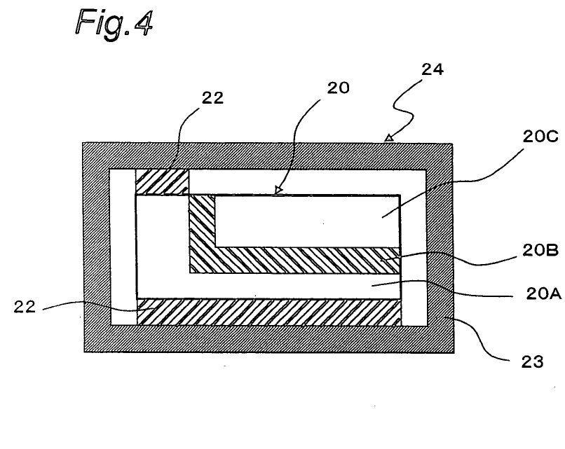

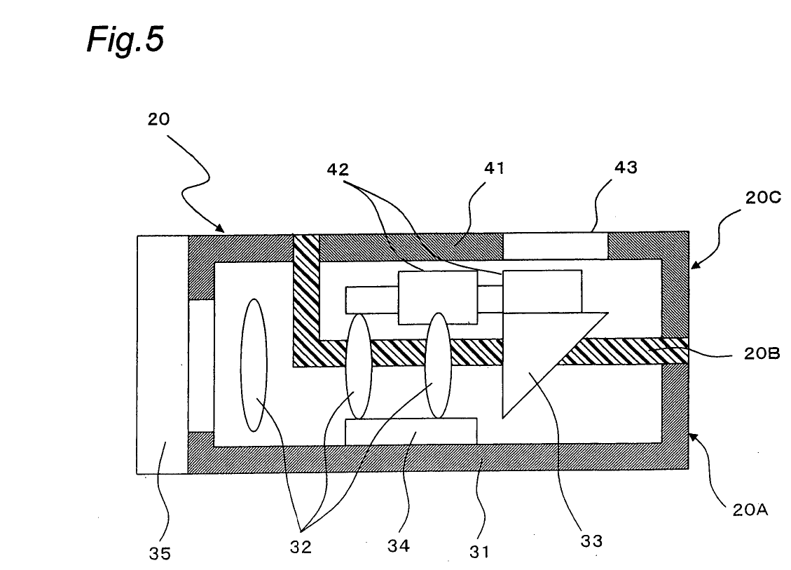

FIG. 4 is a sectional view schematically showing the portable equipment according to the second embodiment of the present invention. FIG. 5 is a sectional view schematically showing a camera module 20 of the essential part of the portable equipment of the second embodiment.

As shown in FIG. 4, the portable equipment 24 of the second embodiment includes the camera module 20 that has an optical zoom function, a second cushioning 20B and a housing 23 that houses therein the camera module 20 and the first cushioning 22.

Moreover, as shown in FIG. 5, the camera module 20 includes an optical component mounting portion 20A as one example of the first camera module portion, a second cushioning 20B and a mechanical component mounting portion 20C (mass body) as one example of the second camera module portion. The mechanical component mounting portion 20C is connected to the optical component mounting portion 20A via the second cushioning 20B.

Moreover, the optical component mounting portion 20A has an optical lens group 32 that can be partially driven for zoom, a CCD photodetecting portion 35 (imaging device) and an optical component mounting portion housing 31 in which the optical lens group 32 is incorporated. Moreover, the mechanical component mounting portion 20C includes mechanical components 42 (mechanical portions) for driving part of the optical lens group 32 and a mechanical component mounting portion housing 41 in which the mechanical components 42 are incorporated. In this case, the CCD photodetecting portion 35 has a construction in which a CCD as one example of the imaging device is mounted on a substrate made of, for example, an alumina ceramic material, and the CCD is fixed to the optical component mounting portion housing 31 with an adhesive in a state in an accurately positioned state in which the center of the CCD coincides with the optical axis of the optical lens group 32.

In the camera module 20, light incident on an optical lens 43 is bent by a prism 33, transmitted through the optical lens group 32 and received by the CCD photodetecting portion 35. Moreover, in order to perform optical zoom, part of the optical lens group 32 is driven along a guide shaft 34 by the mechanical components 42 provided with a motor and a leadscrew, and a distance between the optical lenses is controlled. Although the mechanical components 42 of the mechanical component mounting portion housing 41 drive part of the optical lens group 32 of the optical component mounting portion 20A, the mechanical components 42 and the part of the optical lens group 32 driven by them do not constitute a structure for transmitting an impact. The impact from the optical component mounting portion 20A is transmitted to the mechanical component mounting portion 20C via the second cushioning 20B to the last degree.

Also, in the camera module 20, an adhesive of a high Young's modulus is used for fixing the optical components, and the impact resistance of the adhesive portions is low. Accordingly, in the second embodiment, the camera module 20 is separated into an optical component mounting portion 20A as a first camera module portion and a mechanical component mounting portion 20C as a second camera module portion. The mechanical component mounting portion 20C, which has an impact resistance higher than that of the optical component mounting portion 20A, plays the role of a mass body for impact absorption.

Since the optical component mounting portion 20A has three optical lenses 32, the prism 33, the guide shaft 34 and the CCD photodetecting portion 35, its volume is larger than that of the mechanical component mounting portion 20C of the mass body. Accordingly, the present second embodiment has a construction in which the optical component mounting portion 20A is held by the housing 23 via the first cushioning 22.

In the second embodiment, when an impact is applied to the housing 23, the impact is transmitted to the first cushioning 22, the optical component mounting portion 20A, the second cushioning 20B and the mechanical component mounting portion 20C (mass body) in this order. Even in this order, the impact transmitted to the optical component mounting portion 20A is alleviated by the absorption of the impact by the optical component mounting portion 20A.

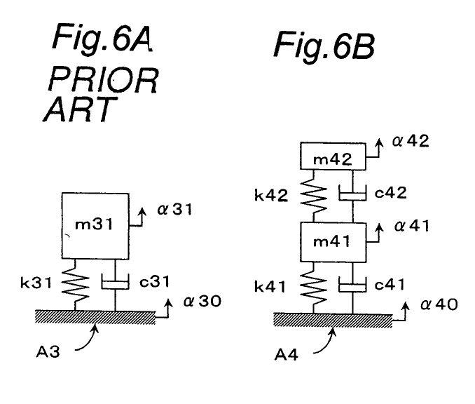

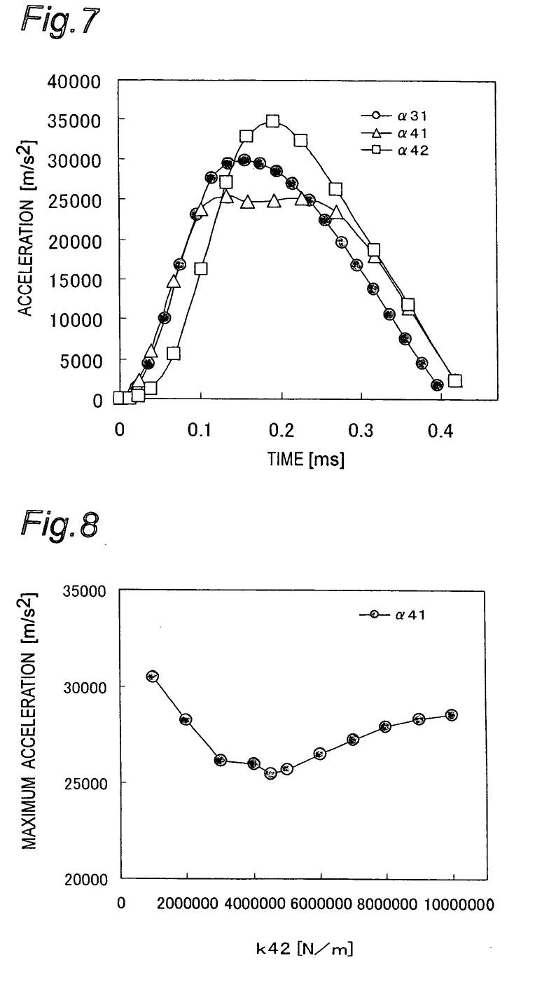

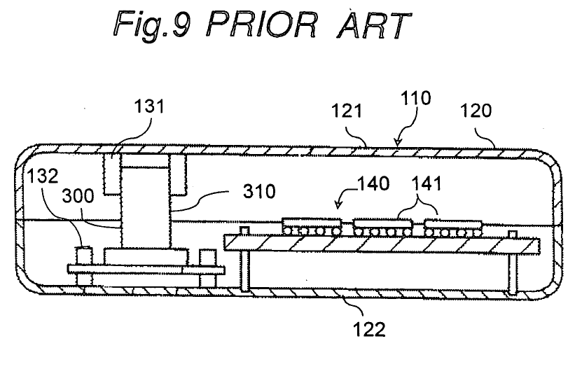

The impact resistance of the portable equipment 24 is described below with reference to the physical models of FIGS. 6A and 6B and FIG. 7 as in the first embodiment.

The physical model A3 of FIG. 6A corresponds to the prior art portable equipment. In FIG. 6A, the physical model A3 has parameters set as follows.

Acceleration of housing: α30 [m/s²]

Spring constant of cushioning: k31=1.5×10⁶ [N/m]

Viscosity coefficient of cushioning: c31=90 [Ns/m]

Acceleration of camera module: α31 [m/s²]

Mass of camera module: m31=25×10⁻³ [kg]

Moreover, the physical model A4 of FIG. 6B corresponds to the portable equipment 24 of the present second embodiment. In FIG. 6B, the physical model A4 has parameters set as follows.

Acceleration of housing 23: α40 [m/s²]

Spring constant of first cushioning 22: k41=1.5×10⁶ [N/m]

Viscosity coefficient of first cushioning 22: c41=90 [Ns/m]

Acceleration of optical component mounting portion 20A: α41 [m/s²]

Mass of optical component mounting portion 20A: m41=15×10⁻³ [kg]

Spring constant of second cushioning 20B: k42=4.5×10⁶ [N/m]

Viscosity coefficient of second cushioning 20B: c42=120 [Ns/m]

Acceleration of mechanical component mounting portion 20C: α42 [m/s²]

Mass of mechanical component mounting portion 20C: m42=10×10⁻³ [kg]

(It is noted that α30=α40.)

FIG. 7 shows the responses of the physical models A3 and A4 to a drop impact. In FIG. 7, the horizontal axis represents time, and the vertical axis represents acceleration. As to the physical model A3, the acceleration α31 generated in the camera module is plotted, while as to the physical model A4, the acceleration α41 generated in the optical component mounting portion 20A and the acceleration α42 generated in the mechanical component mounting portion 20C are plotted.

In the portable equipment of the second embodiment, the camera module 20 is constructed of two constituent elements that have different natural frequencies. The natural frequency of the optical component mounting portion 20A is expressed as:
ω41=\sqrt{k41/m41}≈1.0×10⁴ [rad/s]
and the natural frequency of the mechanical component mounting portion 20C is expressed as:
ω42=\sqrt{k42/m42}≈1.7×10⁴ [rad/s]
That is, ω41<ω42. Therefore, the waveform of the acceleration α42 contains a greater amount of high-frequency components than α41. Therefore, the mechanical component mounting portion 20C responds to a drop impact faster than the optical component mounting portion 20A and absorbs energy due to fall and collision.

For the above reasons, in contrast to the fact that the acceleration reducing effect is 50% in the portable equipment of the physical model A3, the acceleration can be reduced to 42% in the portable equipment of the physical model A4.

A member having elasticity and viscosity of, for example, a viscoelastic body made of rubber or gel, a spring or the like is used for the first cushioning 22 and the second cushioning 20B. The cushioning becomes hard and unable to sufficiently alleviate the impact when the elastic moduli of the first cushioning 12 and the second cushioning 10B are excessively large. Conversely, when the elastic moduli are excessively small, the cushioning is completely collapsed before sufficiently alleviating the impact and becomes unable to alleviate the impact.

FIG. 8 is a graph showing the maximum acceleration at the time of fall and collision when the spring constant k42 of the second cushioning 20B is varied in the second embodiment. The acceleration reducing effect is maximized in the vicinity of the value of the spring constant k42 in the second embodiment. Moreover, when the viscosity coefficient is excessively large, the cushioning becomes hard and is also unable to sufficiently alleviate the impact. Conversely, when the viscosity coefficient is excessively small, the effect of attenuation cannot be obtained, and the impact cannot still be sufficiently alleviated. In the physical model A4 of the present second embodiment, the amount of contraction of the first cushioning is 0.4 mm, and the amount of contraction of the second cushioning is 0.08 mm. Assuming that the thickness of the first cushioning is 1.0 mm and the thickness of the second cushioning is 0.2 mm, then the distortion factor of the cushionings becomes 50% or less, and the impact can sufficiently be alleviated.

As described above, according to the portable equipment 24 of the second embodiment, due to the provision of the optical zoom mechanism, the volume of the optical component mounting portion 20A is large. Therefore, it is difficult for compact portable equipment to interpose the mass body between the portion and the housing unlike the first embodiment. Accordingly, by providing the mechanical component mounting portion 20C, which has an impact resistance higher than that of the optical component mounting portion, as the mass body, the camera module 20 can be downsized.

Moreover, in the second embodiment, the first cushioning 22 and the second cushioning 20B have been formed so that the acceleration generated in the optical component mounting portion 20A at the time of fall and collision has become reducible by the mechanical component mounting portion 20C connected to the optical component mounting portion 20A via the second cushioning 20B. Therefore, the acceleration generated in the optical component mounting portion 20A at the time of fall and collision is reduced in the second embodiment.

As described above, the acceleration generated in the optical component mounting portion 20A that includes the imaging device susceptible to an impact is reduced by absorbing the impact by the vibration of the mechanical component mounting portion 20C even when an impact takes effect on the housing 23. Therefore, the damage due to a drop impact or the like can easily be prevented with a simple construction without increasing the thickness of the cushioning. In addition, since the mechanical component mounting portion 20C that is part of the camera module 10 concurrently serves as the mass body, compact portable equipment excellent in impact resistance can be provided.

Moreover, by reducing the acceleration generated in the optical component mounting portion 20A that has the CCD photodetecting portion 35 and the optical lens group 32 susceptible to an impact by using the mechanical component mounting portion 20C that has the mechanical components 42 as the weight body for impact absorption, the CCD photodetecting portion 35 and the optical lens group 32 can be prevented from being damaged by fall or the like. Moreover, by utilizing the mechanical component mounting portion 20C that has the mechanical components 42 as the weight body, downsizing can be achieved without separately providing a weight body.

Moreover, by making the natural frequency of the mechanical component mounting portion 20C higher than the natural frequency of the optical component mounting portion 20A by setting the mass m41 of the optical component mounting portion 20A, the mass m42 of the mechanical component mounting portion 20C and the spring constants k41 and k42 of the first and second cushionings 22 and 20B when the optical component mounting portion 20A is connected to the housing 23 via the first cushioning 22, the mechanical component mounting portion 20C responds to an impact faster than the optical component mounting portion 20A and effectively absorbs the energy caused by collision, by which the acceleration generated in the optical component mounting portion 20A that includes the imaging device can be reduced.

Furthermore, an optimum value of the spring constant k42 of the second cushioning 20B is obtained by simulation or the like so that the maximum acceleration of the optical component mounting portion 20A is roughly minimized when an impact is applied to the housing 23. By setting the thus-obtained optimum value as the spring constant k42 of the second cushioning 20B, the effect of reducing the acceleration to the optical component mounting portion 20A that includes the imaging device susceptible to an impact is increased.

Moreover, in the portable equipment of the second embodiment in which the optical component mounting portion 20A is connected to the housing 23 via the first cushioning 22, by making the mass of the optical component mounting portion 20A larger than the mass of the mechanical component mounting portion 20C and making the spring constant of the first cushioning greater than the spring constant of the second cushioning, the parameters (masses of the optical component mounting portion 20A and the mechanical component mounting portion 20C and the spring constants and the viscosity coefficients of the first and second cushionings 22 and 20B) for reducing the acceleration generated in the optical component mounting portion 20A that has the imaging device and the optical components susceptible to an impact can easily be designed. Moreover, by reducing the spring constant of the first cushioning 22 that connects the optical component mounting portion 20A to the housing 23, downsizing can easily be achieved by reducing the thickness of the first cushioning 22.

Moreover, by using a third cushioning for connecting the mechanical component mounting portion 20C to the housing 23 in the portable equipment of the second embodiment, the third cushioning can absorb the impact in cooperation with the first and second cushionings.

In the portable equipment of the present invention, the first camera module portion is only required to include at least the imaging device portion. That is, the first camera module portion is required to include only the imaging device portion, allowed to include neither the optical components nor the mechanical portion, allowed to include the imaging device portion and the optical components or allowed to include part of the mechanical portion. Moreover, the second camera module portion plays the role of the mass body for impact absorption and is allowed to include part or the whole of the mechanical portion or part or the whole of the optical components.

Although the present invention has been described as above, it is obvious that the present invention can be modified by a variety of methods. Such modifications are not regarded as departing from the spirit and scope of the present invention, and it is appreciated that improvements apparent to those skilled in the art are fully included within the scope of the following claims.

1. Portable equipment comprising:
a first camera module portion including an imaging device;
a second camera module portion that constitutes a camera module in combination with the first camera module portion;
a housing that houses therein the first and second camera module portions;
a first cushioning that connects either one of the first camera module portion and the second camera module portion to the housing; and
a second cushioning that connects the first camera module portion to the second camera module portion.

2. The portable equipment as claimed in claim 1, wherein
the first camera module portion has the imaging device and an optical component, and
the second camera module portion has a mechanical portion that holds or displaces the optical component.

3. The portable equipment as claimed in claim 1, comprising:
a third cushioning that connects the other of the first camera module portion and the second camera module portion to the housing.

4. The portable equipment as claimed in claim 1, wherein
masses of the first and second camera module portions and spring constants of the first and second cushionings are set so that a natural frequency of the second camera module portion becomes higher than a natural frequency of the first camera module portion.

5. The portable equipment as claimed in claim 2, wherein
masses of the first and second camera module portions and spring constants of the first and second cushionings are set so that a natural frequency of the second camera module portion becomes higher than a natural frequency of the first camera module portion.

6. The portable equipment as claimed in claim 4, wherein,
when the second camera module portion is connected to the housing via the first cushioning, the spring constant of at least the first cushioning is set to a value that a maximum acceleration of the first camera module portion due to an impact applied to the housing is roughly minimized.

7. The portable equipment as claimed in claim 5, wherein,
when the first camera module portion is connected to the housing via the first cushioning, the spring constant of at least the second cushioning is set to a value that a maximum acceleration of the first camera module portion due to an impact applied to the housing is roughly minimized.

8. The portable equipment as claimed in claim 2, wherein,
when the first camera module portion is connected to the housing via the first cushioning, a mass of the first camera module portion is larger than a mass of the second camera module portion, and a spring constant of the first cushioning is greater than a spring constant of the second cushioning.
